(19) United States
(12) Patent Application Publication
(10) Pub. No.: US 2013/0221047 A1
(43) Pub. Date: Aug. 29, 2013

(54) Self securing equipment strap

(71) Applicant: Paul D. Johnson, Knightdale, NC (US)

(72) Inventor: Paul D. Johnson, Knightdale, NC (US)

(21) Appl. No.: 13/385,626

(22) Filed: Feb. 27, 2012

(51) Int. Cl. B62J 11/00; A44B 11/25

(52) U.S. Cl. 224/463; 24/302

(57) ABSTRACT

A strap assembly providing a means to secure large and varying sized articles to the back underside seat rails of a bicycle seat without adding weight or bulk to the bicycle. An attaching loop properly positions the strap assembly to the seat rail, aids in cinching the strap assembly tight and keeps the strap assembly attached to the seat rail when not in use. The attaching loop never permanently tightens so the strap assembly is always easily removed. The strap assembly is small and light enough to fit in a rider's jersey pocket or under-seat tool bag when not in use. The strap assembly negates the need for bicycle equipment bags. The strap assembly can also secure articles to backpacks, garment belts, car-top racks, kayak grab rails, tool boxes, bags and luggage.

### CROSS-REFERENCE TO RELATED PATENTS

Not Applicable

### STATEMENT REGARDING FEDERALLY SPONSORED RESEARCH OR DEVELOPMENT

Not Applicable

### REFERENCE TO SEQUENCE LISTING, TABLE, COMPUTER PROGRAM, COMPACT DISC

Not Applicable

### BACKGROUND OF THE INVENTION

This invention relates to securing articles of varying sizes and shapes to a structure, without the need of a bag or enclosure, with a strap assembly that can be easily attached and unattached to the same structure and is adequately sized to carry in a shirt pocket.

When riding a bicycle over the course of a day or days the weather conditions can vary drastically from cold and overcast in the morning to hot and sunny in the afternoon or visa versa. This requires equal clothing variations ranging from hats, gloves, leggings, booties and jackets to shorts and sleeveless shirts. As the weather varies throughout the day the rider needs to either shed or put on warmer clothing but has very few desirable options for storing the clothes when not worn. Storage capabilities on a bicycle are typically limited to presized bags attached at various locations on the bicycle. These bags add weight and bulk to the bicycle and are not streamline looking or aerodynamic. Today's minimalist road cyclist does not want to clutter up the clean aesthetics lines of their road bike with these bags. Attaching a bag under the seat is one acceptable location for bag mounting but that position is usually reserved for only a small tool bag. Even what is considered a large under-seat bag is not adequate to hold the bulkiness of unworn clothing. The addition of an under-seat bag large enough for clothing articles generally requires that the small under-seat tool bag be removed. When bags of various styles and attachment locations are used they typically are loosely attached to the bicycle allowing the bag to jostle around causing the bag and attachment means to rub against the bicycle and thus abrade the bicycle's highly polished finish. By nature of any bag, it's maximum capacity is fixed and can be large enough for one ride but not adequate for another. This requires the cyclist to purchase and mount various sized bags prior to each ride depending on the perceived storage needs of that particular ride.

Another means of storage is the back pockets in a bicycle riding jersey. While these pockets are convenient and being in the back are aerodynamic they are very limited in size and weight carrying capabilities. They are usually used for food, maps and other small light miscellaneous articles leaving very little room for unworn clothing. If they are used for unworn clothing the increased weight of the clothes cause the jersey to pull down around the rider's shoulders and neck creating a discomforting fit and chaffing around the neck. When the jersey pockets are over stuffed they tend to bounce around which exasperates this discomfort and chaffing. All of this pulling, chaffing and bouncing take the riders concentration and enjoyment away from the ride.

Typical road bike riding shorts are form fitting to be aerodynamic and do not offer pockets of any type. A rider can however place unworn clothing in the waistband of the shorts or tie the clothing around their waist. Both of these options are counter productive to all the efforts applied toward the rider and their road bike being aerodynamic and minimal. Sometimes very small articles can be placed just under the leg of the tight shorts but this works for only the lightest of objects that won't slide out during the ride due to the continual up and down movement of each leg.

Some larger equipment carriers for bicycles, called panniers, require mechanical attachment to the bicycle frame with screws or clamps. These are more for touring and not typically associated with the light weight aerodynamic road bikes. They take time and tools to install which increases the potential of nicking and scratching the surfaces of the highly prized bicycle frame paint. They also add undesired weight to the bicycle and take away from the minimalistic and aerodynamic look of the bike.

Similar problems for carrying articles exist in other applications. These applications will be addressed in the summary, figures, description and claims.

### BRIEF SUMMARY OF THE INVENTION

This invention is a strap assembly consisting of a length of strap with affixed attaching loop, fastening means and length adjustment means. The strap assembly provides a means to secure unworn clothing or extra articles to a bicycle or any mounting structure without all the hindrances mentioned in the background of this disclosure.

This strap assembly can secure anything to the under back side of a bicycle seat that one can get strap around such as clothes, water bottles, food or shoes. Small loose articles can even be secured by wrapping them inside the larger stored articles and therefore be secured to the bicycle as well. The adjustability of the strap length allows the rider to store any size article within the strap's length capability and bicycle's available free space without having to pre determine the required storage needs. The strap assembly positions the stored articles aerodynamically behind the rider and neither the strap assembly nor articles interfere nor come in contact with the riders' legs while pedaling so that the articles are not distracting to the rider. The articles become their own storage container so the added weight to the bicycle is minimized to only the weight of the strap assembly itself. The size and weight of the strap assembly is equivalent to other small articles usually carried in a jersey pocket, stored in the under-seat tool bag, stuffed under the leg of the bike shorts or wrapped around the seat stem so that it doesn't detract from the minimalistic look of the bicycle when not in use. Since it is small and light enough to remain stored on the bicycle it is therefore always available when needed and doesn't need to be pre-installed. Any under-seat tool bag does not have to be removed to allow articles to be secured to the backmost portion of the bicycle seat. As the strap assembly secures the articles to the seat tightly, the articles don't jostle around while riding. This coupled with the strap being made of a soft pliant material means the articles or strap assembly doesn't mar any surface of the bicycle frame. This tight securement to the seat also makes the articles move with the bicycle so they are completely undetectable and forgotten by the rider once secured. With the ability to store excess gear on the bicycle, the rider's back jersey pockets don't need to be used for the heavier and bulkier unworn clothing articles and can now be reserved for those light weight articles that don't ruin the fit and feel of the jersey. There is also no more need for the rider to stuff unworn articles in waistbands or tie clothing around their waist or mount large bike bags or panniers.

The strap assembly has an affixed attaching loop that attaches the strap assembly to the bicycle or any mounting structure. No tools are required to attach the strap assembly and it takes only seconds to accomplish. This attaching loop not only keeps the strap assembly attached to the bicycle when not in use, it is designed such that once the fastening means is connected, the fastening means position is held in place relative to the stored articles so that it is easily accessible and keeps the strap assembly from sliding around the articles while the strap assembly is being cinched securely around the articles. This attaching loop does not tighten on itself like a knot in a rope allowing the strap assembly to be removed as easily as initially attaching it.

Other applications for this strap assembly and structures can be: attaching articles to the handlebars and other areas on a bicycle; attaching equipment to backpack frames; attaching articles to an individual's belt to create a fanny pack; attaching to a car top rack to hold additional equipment; securing articles or paddles to a kayak's grab rails; attaching to ladder rungs to secure paint cans or tool pouches; creating additional storage for tool boxes or tool bags; providing additional carrying capacity or easily retrievable storage on the outside of luggage; securing a boat's convertible top to it's frame when not in use; securing articles to any frame, structure or attachment point where the strap assembly can be utilized to secure articles and the strap assembly is desired to remain in place when is not in use.

### BRIEF DESCRIPTION OF THE SEVERAL VIEWS OF THE DRAWING

FIG. 1 illustrates the top view of the present invention strap assembly with affixed attaching loop, fastening means with integral adjustment means.

FIG. 2 illustrates the side view of the present invention strap assembly with affixed attaching loop, fastening means with integral adjustment means.

FIG. 3 illustrates how the strap and attaching loop attach the present invention strap assembly to a structure.

FIG. 4 illustrates the present invention strap assembly securing articles to the back seat rail of a bicycle seat.

FIG. 5 illustrates the fastening means with integral adjustment means.

FIG. 6 illustrates the cross sectional details of the fastening means's integral adjustment means.

FIG. 7 illustrates the first step in installing the present invention strap assembly to the seat rail.

FIG. 8 illustrates the present invention strap assembly attached to the seat rail by the attaching loop.

FIG. 9 illustrates storing the present invention strap when not in use by leaving it attached to the bicycle seat rails or wrapped around the seat post.

FIG. 10 illustrates the present invention sharing the attachment point with an under seat tool bag.

FIG. 11 illustrates the present invention with multiple attaching loops.

FIG. 12 illustrates the present invention securing equipment in multiple locations to a backpack.

FIG. 13 illustrates the present invention attached to an individual's belt to make fanny pack.

FIG. 14 illustrates the present invention securing additional articles to a car top carrier.

FIG. 15 illustrates the present invention securing unused articles and a kayak paddle to a kayak's grab rails.

FIG. 16 illustrates the present invention securing a paint can to a ladder.

FIG. 17 illustrates the present invention creating additional article storage to a tool bag.

FIG. 18 illustrates the present invention providing additional carrying capacity and easily retrievable storage to the outside of luggage.

FIG. 19 illustrates the present invention securing a boat's convertible top to the top's framework when not in use.

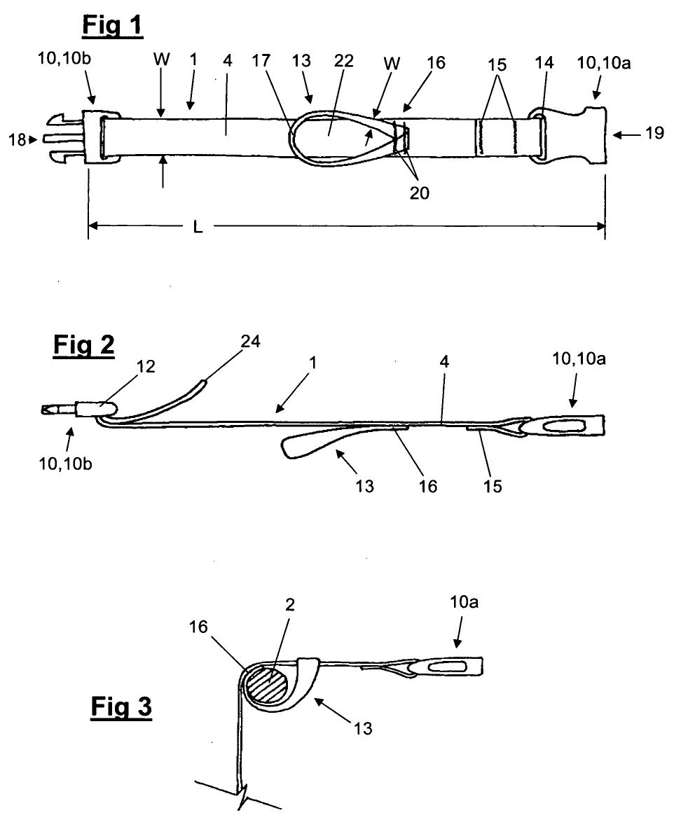

### DETAILED DESCRIPTION OF THE INVENTION

Before one or more embodiments of the invention are explained in detail, it is to be understood that the invention is not limited in it's application to the details of construction described herein or as illustrated in the figures. The invention is capable of other embodiments and of being practiced or carried out in various other ways. Further, it is to be understood that the phraseology and terminology used herein is for the purpose of description and should not be regarded as limiting. This disclosure references only one strap assembly but two or more identical strap assemblies would typically be used to secure articles. The descriptions herein apply to the use of any number of strap assemblies for any application. For brevity and clarity a single application has been chosen for description details when application details are required to convey a full understanding. Because of the origin of the invention this single application will specifically references road bikes and road bike cyclists but these same descriptions apply to any use of the invention either stated in the background of the invention or unstated. For purposes of this patent the term, in any form:
“article” and “clothing” refer to any and all items that are stored and secured for any length of time using the present invention;
“secure” refers to the holding firmly to a structure without any additional motion such as flopping or wagging regardless of the vibrations, shaking or motion of that structure;
“structure” refers to any element, solid or pliable, that the present invention is being attached to as a means to secure articles to that same structure;
“cinch” refers to the tightening of the strap around the articles and structure until they are adequately secure;
“fastening means” refers to any readily available strap fastening means that meets the requirements defined in the description;
“seat rail” is one specific structure referring to the metal rod supporting the underside of a bicycle seat;
“bicycle application” refers to use on a bicycle where the articles are usually limited to only a few pounds, the structure is assumed to be the seat rails, and the strap assembly is assumed to secure the articles to the seat rails on the back underside of the bicycle seat;
“load” refers to the internal mechanical stresses throughout the strap assembly components, either tensile or compressive, created while cinching and securing the articles;
“ride” refers to a bicycle riding trip of any duration;
“rider” and “cyclist” refers to the bicycle rider and user of the present invention;
“road bike” is used to describe bicycles built for traveling at speed on paved roads, the tires are narrow and under high-pressure, use multiple derailleur gears, and tend to be of a lightweight, streamlined and minimalist construction.

(See FIG. 1, 2) A present invention strap assembly 1 consists of a length of a strap 4, a fastening means 10, an adjustment means 12 and an attaching loop 13.

(See FIG. 1, 4, 5) The strap 4 can be any pliant ribbon-like, cord-like, fabric-like, rope-like material such as, but not limited to, cotton, jute, nylon, polyester or polypropylene. These materials work well for any readily available fastening means 10 and their softness keeps the strap 4 from abrading or scratching the surface of a mounting structure 2 or a stored article 3. The cross sectional shape of the strap 4 can be of any configuration such as but not limited to flat, round or oval as long as the fastening means 10 can accommodate the shape. For clarity and consistency and mating with the preferred fastening means 10 the figures assume a flat rectangular cross sectional shape for the strap 4. The strength of the strap needs to be sufficient to withstand the strap 4 load while cinching the strap assembly 1 around the articles 3 and a seat rail 2 as well as any additional stresses due to vibration and shock induced by a bicycle seat 8 and seat rail 2 as the bicycle is being ridden. For the bicycle application, strap width of half inch is more than sufficient. While smaller strap widths would be adequately strong for the bicycle application, that smaller size becomes impractical for the riders fingers to manipulate the associated smaller fastening means 10 and the adjustment means 12. Strap widths and lengths for the bicycle application are therefore more of a personal choice and does not effect the concepts of the present invention. For significantly heavier loads in non-bicycle applications, the strap assembly 1 and the fastening means 10 sizing is determined by the loads created by the weight and size of the articles being secured. In the bicycle application the amount of articles 3 secured are limited only by a distance 7 between the bottom of the bicycle seat 8 and a bicycle back tire 9 or any other fixture on the bicycle that would interfere with the stored articles 3. Strap lengths of twelve inches is sufficient to hold the most common unused clothing articles 3 once rolled up without adding unnecessary bulk to the strap assembly 1 when it is not in use. The maximum required strap length for other applications is the minimal length required to wrap around the articles 3 and mounting structure 2.

(See FIG. 1, 2, 3, 4, 10) The attaching loop 13 can be of a material similar to the strap 4. A width one half the strap width works well making it more pliant than the strap 4 and therefore easier to manipulate when attaching the strap assembly 1 to any structure 2. The two sides of the attaching loop together can support the exact same loading as a single length of strap 4. For the bicycle application the size of an attaching loop opening 22 is adequately large to allow either fastening means end 10a, 10b or strap 4 to be easily fed through the attaching loop opening 22 during installation. Larger attaching loop openings 22 can be required if mounting structures 2 in non bicycle applications are larger than either fastening means end 10a, 10b or strap 4 end. The attaching loop 13 is affixed to the strap 4 at an affixing point 16 where the strap 4 is desired to be positioned relative to the structure 2. The attaching loop 13 is affixed to the strap 4 by, but not limited to, stitching, heat welding, ultrasonic welding, adhesives, etc. The affixing method must create a first joint 20 sufficiently strong to withstand the load within the strap 4 when cinching the strap assembly 1 around the articles 3 and mounting structure 2. Once the strap assembly 1 is securely cinched, the attaching loop 13 no longer carries the cinching load and is only subjected to loads required to keep the strap 4 rotationally oriented relative to the mounting structure 2. An attaching loop end 17 is pointed away from the non-adjustable fastening means end 10a. In this way when a strap free end 24 is pulled in a pull direction 21 for cinching, the first joint 20 is in evenly distributed pure shear. This even distribution of stresses throughout the entire first joint 20 creates a stronger joint. One attaching loop 13 is described for each strap assembly 1, however if various affixing points 16a, 16b, 16c are desired for the same strap assembly 1 multiple attaching loops 13a, 13b, 13c can be affixed to the strap 4 in various desired affixing points 16a, 16b, 16c on either side of the strap 4.

(See FIG. 1, 5, 6) The fastening means 10 can be any readily available design that will accept the particular strap 4 selected and has the ability to connect a first free end 18 and a second free end 19 of the strap assembly 1 together into one contiguous element. The present invention is not dependant on the specific fastening means 10 nor will it be elaborated on in this description. Any pre-disclosed strap 4 fastening means 10 can be used, such as, but not limited to, side snap, spring lock, belt buckles of any design, double D ring buckles, cam locks, friction locks, etc. This description assumes a plastic two part fastening means end 10a, 10b with a side snap 11 and an integral strap 4 length adjustment means. These features are described in patent D502,671S issued to Manabu Yoshiguchi Mar. 8, 2005 and those similar features are assumed in this description but are not being claimed by this present invention. For description purposes any further references to fastening means pertain to this type of pre-disclosed design. The preferred fastening means 10 works well for the bicycle application because it's unaffected by water, is light weight, connects and unconnects without tools and can support the strap assembly loading. The strap length adjustment means 12 is designed into the adjustable fastening means end 10b. This integral adjustment means 12 allows the strap 4 to slide through it in a first direction 27 when the strap free end 24 is pulled in the pull direction 21 to cinch the strap 4 securely around the articles but locks the strap 4 from sliding back out in an opposite direction 28 once the cinching load on the strap free end 24 is released. This locking of the strap's 4 sliding motion is disengaged by lifting the adjustment means 12 in a second direction 29 away from the strap 4. The non adjustable fastening means end 10a is affixed to the strap 4 by feeding the strap 4 through a strap hole 14 and joining the strap 4 to itself at one or more of a second joint 15. The joining method can be similar to that used to create the attaching loop first joint 20. The adjustable fastening means end 10b is affixed to the strap 4 by feeding the strap 4 through the integral adjustment means 12.

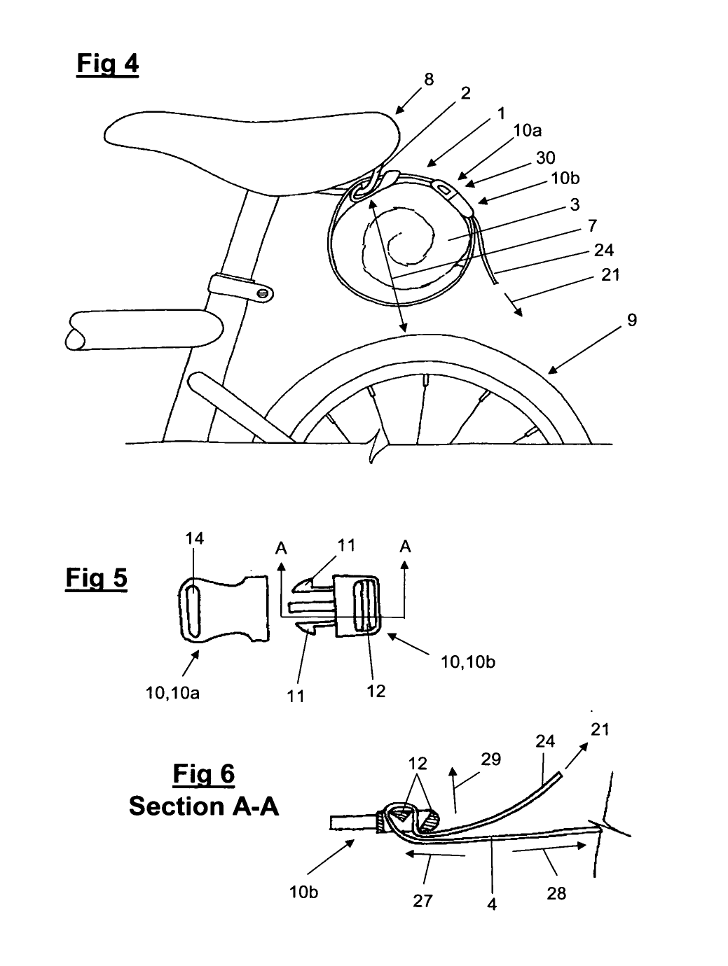

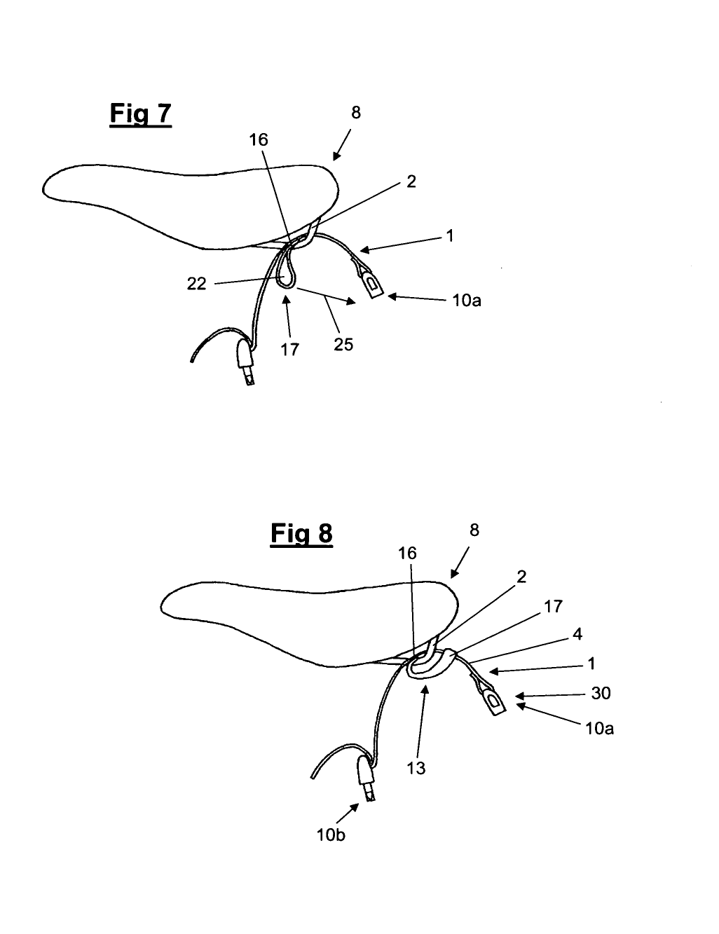

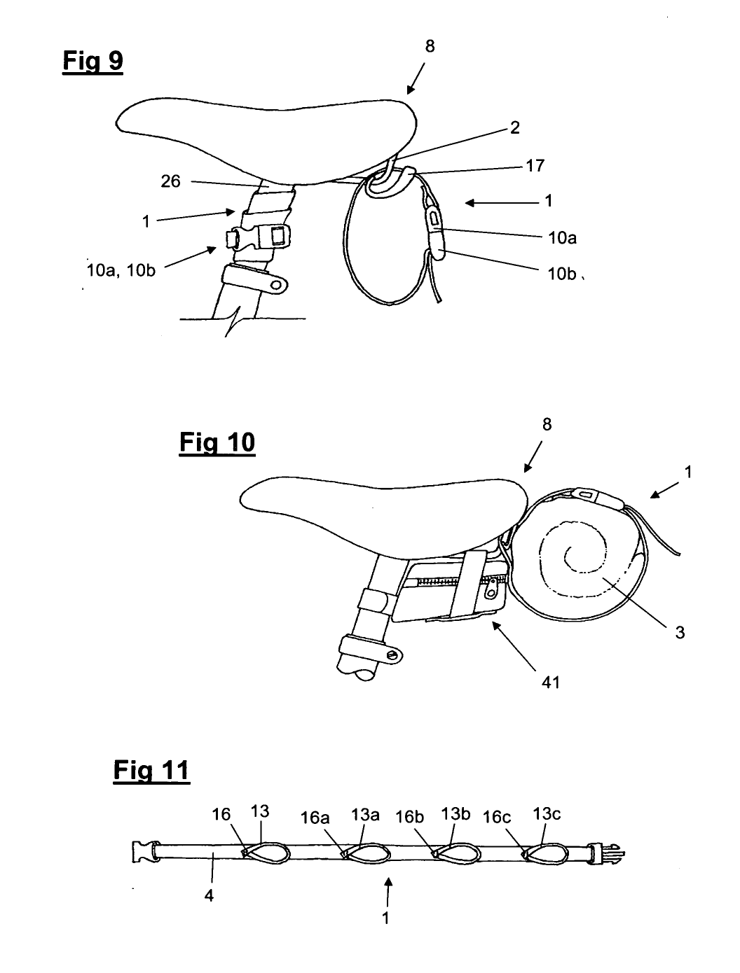

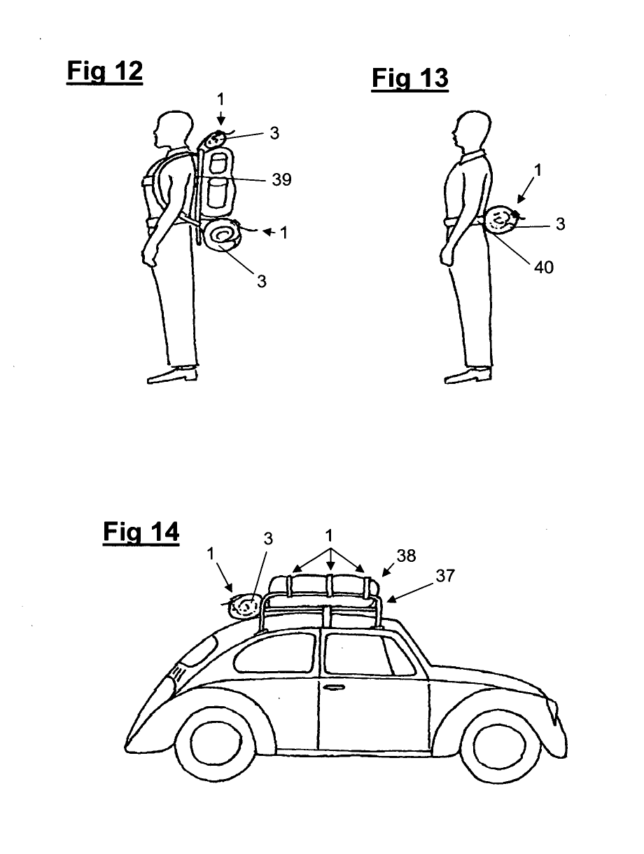

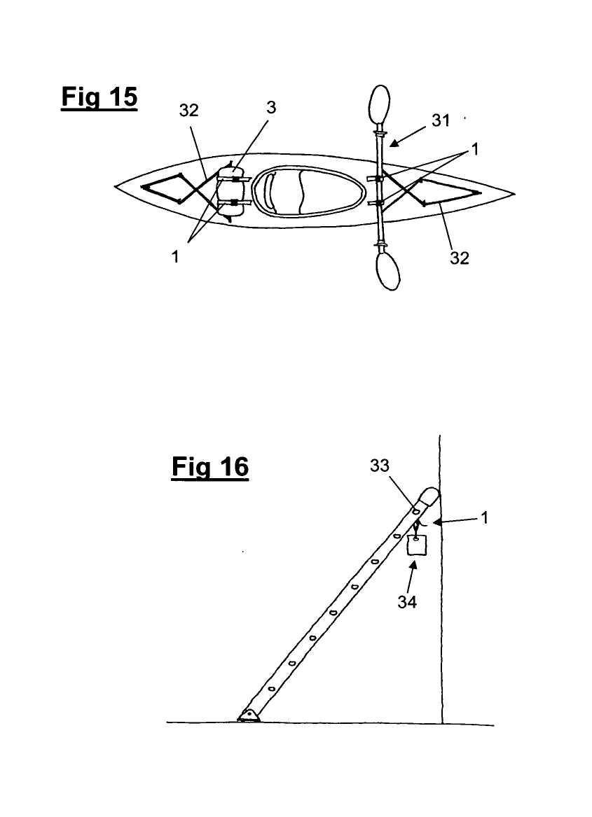

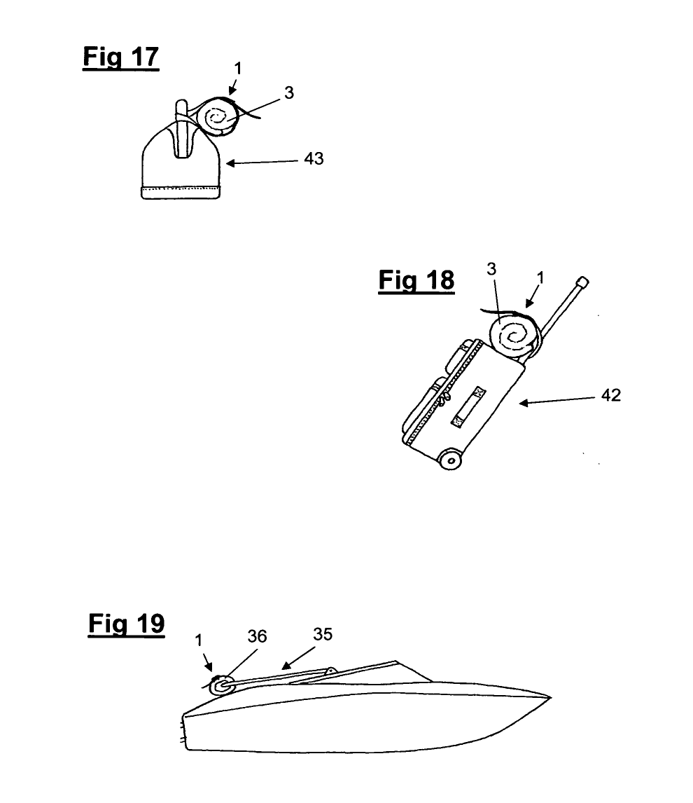

(See FIG. 4, 7, 8, 10) To attach the strap assembly 1 in the bicycle application the non-adjustable fastening means end 10a is threaded over the seat rail 2 until the attaching loop affixing point 16 is in proximity of the seat rail 2. The attaching loop end 17 is then brought under the seat rail 2 in a third direction 25 toward the non-adjustable fastening means end 10a. The non-adjustable fastening means end 10a of the strap is then fed through the attaching loop opening 22 such that the attaching loop 13 encircles both the seat rail 2 and strap 4 as shown in FIG. 8. The attaching loop affixing point 16 on the strap 4 places the non-adjustable fastening means end 10a at a specific location 30 relative to the seat rail 2 where it is easily seen and accessible on top of the articles 3 and the pull direction 21 for cinching the strap free end 24 is away from the bicycle seat 8 and any other obstructions. In the bicycle application this attachment is possible even with an under-seat tool bag 41 present. This same process applies to mounting any article 3 onto any mounting structure 2.

(See FIG. 4) To secure the articles 3 they are rolled up or otherwise manipulated in a manner that they are self contained and can be held by the strap assembly 1. In the bicycle application they are placed just behind and under the bicycle seat 8 with the non adjustable fastening means end 10a laying on top of the articles 3. The adjustable fastening means end 10b is wrapped around the articles 3 and connected into the non adjustable fastening means end 10a. The strap assembly 1 now completely encircles the articles 3 and seat rail 2. The strap assembly 1 is securely cinched around the articles 3 by pulling the strap's free end 24 in the pull direction 21 away from the fastening means 10. While cinching the strap assembly, the fastening means 10 is held stationary by the attaching loop 13 where it is attached to the seat rail 2.

(See FIG. 8) To remove the strap assembly 1 from the seat rail 2 in the bicycle application once the fastening means ends 10a, 10b have been unconnected and the articles 3 removed, the rider reverses the installation process by feeding the non adjustable fastening means end 10a back through the attaching loop opening 22 and over the seat rail 2. Because the attaching loop 13 has no means to tighten on itself or the strap 4 like a knot, once the strap tension from cinching and securing is removed, the attaching loop 13 is as loose as when the original attachment was made regardless of how long a time period the strap assembly 1 and attaching loop 13 have been in the secured position or how much vibration they have been subjected to making the strap assembly 1 as easy to remove as it was to originally attach.

(See FIG. 8, 9) The strap assembly 1 can be stored when not in use by wrapping it around a bicycle seat post 26 and connecting the mating fastening means ends 10a, 10b together. The strap assembly 1 can also be left to hang loose from the seat rail 2 by just the attaching loop 13 as shown in FIG. 8 or by connecting the fastening means ends 10a, 10b together. The pliability of the strap 4 and attaching loop 13 affords the user to alternately roll up or wad up the strap assembly 1 for storage in any convenient location such as a pants pocket, jersey pocket, under-seat tool bag 41 or even under a tight fitting riding shorts pant leg.

(See FIG. 11, 12, 13, 14, 15, 16, 17, 18, 19) The strap assembly 1 can have multiple uses in addition to the bicycle application such as but not limited to attaching unused articles 3 to a backpack 39, an individual's belt 40 to create a fanny pack, attaching to a car top rack 37 to hold additional articles 3 or for securing a car top carrier bag 38 to the car top rack 37, securing unused articles 3 or a paddle 31 to a kayak's grab rails 32, attaching to a ladder rung 33 to secure a paint can 34, creating additional storage for tool boxes or tool bags 43, providing additional carrying capacity or easily retrievable storage on the outside of a luggage case 42, attaching to a boat's convertible top frame 35 to secure a convertible top 36 when not in use, or attaching to any frame or structure 2 or attachment point where the strap assembly 1 can be utilized to secure or store articles 3 wherein the strap is desired to remain in place when not in use and to be easily removed.

What is claimed:

1. A strap assembly comprising:
a strap being of sufficient length to encompass an article and a structure;
a fastening means that allows a first end and a second end of the strap to be connected and unconnected, the fastening means being connected to at least one of the first or second ends;
an adjustment means for changing the strap length between it's first and second ends;
an attaching loop being sufficiently large to allow one of the first end or second end or fastening means to pass through it.

2. The strap assembly of claim 1 being adjustable in size to secure the article up to the limits of the strap length.

3. The strap assembly of claim 1 that is attached to and removed from the structure without tools.

4. The strap assembly of claim 1 wherein the articles are their own container and therefore the added weight and bulk for securing the articles is minimized to the weight and bulk of the strap assembly only.

5. The strap assembly of claim 1 wherein the attaching loop is positioned and affixed to the strap such that when the strap assembly is attached to the structure one of the first end or second end or fastening means is reachable without interference and visually accessible to the user.

6. The strap assembly of claim 1 wherein the attaching loop is positioned and affixed to the strap such that when the strap assembly is attached to the structure the strap assembly is kept from rotating around the articles when the strap is being cinched securely around the articles.

7. The strap assembly of claim 1 wherein the structure can include backpacks, garment belts, car-top racks, kayak grab rails, tool boxes, bags, luggage and boat convertible tops.

8. A bicycle strap assembly comprising:
a strap being of sufficient length to encompass an article and a bicycle structure;
a fastening means that allows a first end and a second end of the strap to be connected and unconnected, the fastening means being connected to at least one of the first or second ends;
an adjustment means for changing the strap length between it's first and second ends;
an attaching loop being sufficiently large to allow one of the first end or second end or fastening means to pass through it.

9. The bicycle strap assembly of claim 8 being adjustable in size to secure the article up to the limits of the strap length.

10. The bicycle strap assembly of claim 8 that is attached to and removed from the bicycle structure without tools.

11. The bicycle strap assembly of claim 8 wherein the articles are their own container and therefore the added weight and bulk for securing the articles is minimized to the weight and bulk of the strap assembly only.

12. The bicycle strap assembly of claim 8 wherein the attaching loop is positioned and affixed to the strap such that when the bicycle strap assembly is attached to the bicycle structure one of the first end or second end or fastening means is reachable without interference and visually accessible to the user.

13. The bicycle strap assembly of claim 8 wherein the attaching loop is positioned and affixed to the strap such that when the bicycle strap assembly is attached to the bicycle structure the strap assembly is kept from rotating around the articles when the strap is being cinched securely around the articles.

14. The bicycle strap assembly of claim 8 that is small enough to fit in a rider's under-seat tool bag or garment pocket.

15. The bicycle strap assembly of claim 8 that positions articles tightly against the bicycle structure such that they follow the normal movement of the bicycle and are undetectable to the rider as they ride the bicycle.

16. The bicycle strap assembly of claim 8 that can utilize the same mounting attachment point at the same time with the small under-seat tool bag.

17. The strap assembly of claim 8 wherein the structure can include backpacks, garment belts, car-top racks, kayak grab rails, tool boxes, bags, luggage and boat convertible tops.

18. A strap loop attachment means comprising:
an attaching loop being sufficiently large to allow one of a first end or a second end or a strap fastening means to pass through it.

19. The attaching loop of claim 18 wherein the attaching loop is positioned and affixed to a strap such that when the strap is attached to a structure one of the first end or second end or strap fastening means is reachable without interference and visually accessible to a user.

20. The strap assembly of claim 18 wherein the attaching loop is positioned and affixed to a strap such that when the strap is attached to a structure the strap is kept from rotating around an article when the strap is being cinched securely around the article.
